(19) United States
(12) Patent Application Publication
(10) Pub. No.: US 2025/0115186 A1
(43) Pub. Date: Apr. 10, 2025

(54) DIGITAL REAR MIRROR FOR EASY OPERATION BASED ON BUTTON OR SENSOR, AND OPERATING METHOD OF THE SAME

(71) Applicant: THINKWARE CORPORATION, SEONGNAM-SI (KR)

(72) Inventors: Ho Kwan LEE, SEONGNAM-SI (KR); Hyun Jin BANG, SEONGNAM-SI (KR); Hyun Chul CHO, SEONGNAM-SI (KR); Hae Jong CHOI, SEONGNAM-SI (KR)

(21) Appl. No.: 18/906,447

(22) Filed: Oct. 4, 2024

(30) Foreign Application Priority Data
Oct. 6, 2023 (KR) 10 2023 0133006
Nov. 14, 2023 (KR) 10 2023 0157753
Sep. 30, 2024 (KR) 10 2024 0132519

(51) Int. Cl. B60R 1/28; H04N 23/695

(52) U.S. Cl. CPC B60R 1/28; H04N 23/695; B60R 2300/207; B60R 2300/8046

(57) ABSTRACT

The present disclosure provides a digital rear mirror device for easy operation based on a button or a sensor and an operating method of the same. In the present disclosure, the digital rear mirror device may be configured to, in response to at least one button arranged on at least one edge of a display module, display identification information on an operation function assigned to the button through the display module. Here, the button may include at least one of a physical button and a touch button. In the present disclosure, the digital rear mirror device may be configured to switch the display module based on a signal detected through at least one sensor that is arranged on at least one edge of the display module. Here, the sensor may include at least one of a motion sensor, a proximity sensor, and a touch sensor.

### CROSS-REFERENCE TO RELATED APPLICATION(S)

This application claims the priority benefit under 35 U.S.C. § 119 to Korean Patent Application No. 10-2023-0133006, filed on Oct. 6, 2023, Korean Patent Application No. 10-2023-0157753, filed on Nov. 14, 2023, and Korean Patent Application No. 10-2024-0132519, filed on Sep. 30, 2024, in the Korean Intellectual Property Office, the entire contents of which are incorporated herein by reference in their entirety.

### BACKGROUND

### 1. Field

The present disclosure relates to a digital rear mirror (DRM) device for easy operation based on a button or a sensor, and an operating method of the same.

### 2. Description of Related Art

A driver that drives a vehicle needs to keep an eye on the rear while looking ahead during driving. To this end, the vehicle is equipped with a rear mirror (which may also be referred to as one of rear view mirror, back mirror, room mirror, and inside mirror). That is, the driver verifies the rear through the rear mirror while maintaining the forward-facing posture. However, due to a separate loading box providing a space for a passenger, an object, or a cargo behind the driver, a rear view of the driver is often blocked. This may lead to various risks.

For the above reasons, a digital rear mirror device is currently being mounted to a vehicle. The digital rear mirror device displays a video captured by a rear camera of the vehicle. Through this, the digital rear mirror device provides an unobstructed rear view to the driver. The digital rear mirror device is manipulated by the driver for various reasons while driving the vehicle. Therefore, an easy operation of the digital rear mirror device is required.

### SUMMARY

The present disclosure provides a digital rear mirror device for easy operation based on a button or a sensor and an operating method of the same.

In the present disclosure, a digital rear mirror device of a vehicle may include a display module configured to provide a rear view of the vehicle, an input module including at least one button arranged on at least one edge of the display module, and a processor configured to connect to each of the display module and the input module and to display identification information on an operation function assigned to the button in response to the button through the display module.

In the present disclosure, a digital rear mirror device of a vehicle may include a display module configured to provide a rear view of the vehicle, at least one sensor arranged on at least one edge of the display module, and a processor configured to connect to each of the display module and the sensor and to switch the display module based on a signal detected through the sensor.

In the present disclosure, an operating method of a digital rear mirror device of a vehicle may include providing a rear view of the vehicle through a display module, and, in response to at least one button arranged on at least one edge of the display module, displaying identification information on an operation function assigned to the button through the display module.

In the present disclosure, an operating method of a digital rear mirror device of a vehicle may include providing a rear view of the vehicle through a display module, and switching the display module based on a signal detected through at least one sensor arranged on at least one edge of the display module.

According to the present disclosure, a digital rear mirror device may continuously provide a rear view of a vehicle. In detail, the digital rear mirror device may provide the rear view of the vehicle by directly illuminating the rear view of the vehicle through reflection of light in a mirror mode and by displaying a rear view video of the vehicle acquired by a camera device in a display mode. Accordingly, a driver of the vehicle may keep an eye on the rear while looking ahead during driving.

According to a first feature, a digital rear mirror device may help a user intuitively identify the purpose of a button and enables a button-based easy operation in the digital rear mirror device by displaying identification information at least one button while providing a rear view of the vehicle through a display module. According to a second feature, the digital rear mirror device enables a sensor-based easy operation in the digital rear mirror device by switching the display module based on a signal detected through at least one sensor. Such features allow a driver of the vehicle to easily operate the digital rear mirror device while driving. In addition, such features may reduce a size of the digital rear mirror device that includes at least one of a button and a sensor and may simplify the structure, which may lead to reducing the manufacture cost of the digital rear mirror device.

### BRIEF DESCRIPTION OF THE DRAWINGS

FIG. 1 is a diagram for describing a digital rear mirror device according to various example embodiments.

FIG. 2 is a diagram illustrating a configuration of the digital rear mirror device of FIG. 1.

FIGS. 3A, 3B, 3C, and 3D are views for describing examples of the digital rear mirror device of FIG. 2.

FIG. 4 is a flowchart illustrating an operating method of a digital rear mirror device according to a first example embodiment.

FIG. 5 is a flowchart illustrating an operating method of a digital rear mirror device according to a second example embodiment.

FIG. 6 is a block diagram illustrating a vehicle to which a digital rear mirror device is mounted according to various example embodiments.

FIG. 7 is a block diagram illustrating a control device of the vehicle of FIG. 6.

### DETAILED DESCRIPTION

Hereinafter, various example embodiments of the present document are described with reference to the accompanying drawings.

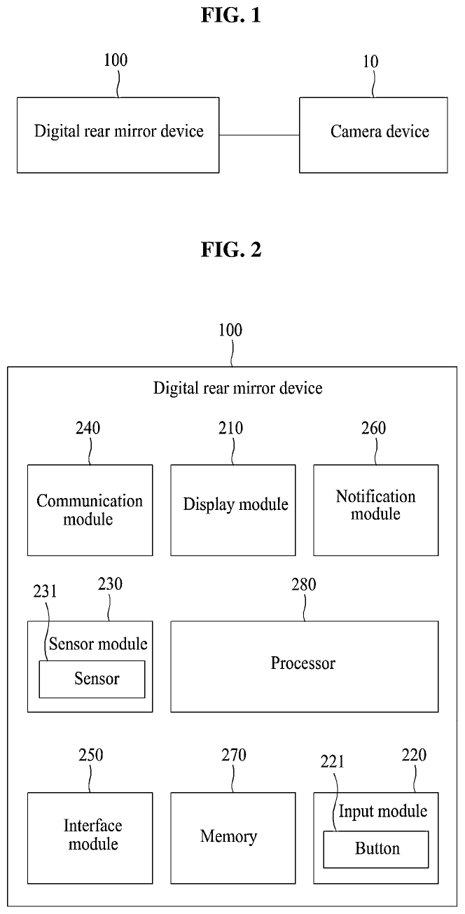

FIG. 1 is a block diagram for describing a digital rear mirror device 100 according to various example embodiments.

Referring to FIG. 1, the digital rear mirror device 100 may be mounted to a vehicle with at least one camera device 10. The digital rear mirror device 100 may be mounted within a driver's field of view range in the vehicle. The digital rear mirror device 100 may be connected to the camera device 10. In some example embodiments, at least one electronic device (e.g., video processing device) (not shown) may be added between the digital rear mirror device 100 and the camera device 10.

The camera device 10 and the digital rear mirror device 100 may be communicatively connected in a wired or wireless manner. In some example embodiments, the camera device 10 and the digital rear mirror device 100 may be connected through a communication cable. In an example embodiment, the camera device 10 and the digital rear mirror device100 may perform communication using an analog method. The analog method may include, for example, analogue high definition (AHD). In another example embodiment, the camera device 10 and the digital rear mirror device100 may perform communication using a digital method. For example, the digital method may include a serial transmission method. In this case, the camera device 10 may include a serializer, and the digital rear mirror module 110 may include a deserializer. However, without being limited thereto, and the camera device and the digital rear mirror device100 may be connected through an in-vehicle network communication (e.g., controller area network (CAN) communication). The camera device 10 and the digital rear mirror device100 may include various communication chips.

The camera device 10 may acquire video information on a surrounding environment of the vehicle. In some example embodiments, the camera device 10 may store the video information in a memory within the camera device 10. The video information may include a rear view video of the vehicle. To this end, the camera device 10 may be mounted on back of the vehicle toward the rear of the vehicle.

The digital rear mirror device 100 may display the video information acquired by the camera device 10. To this end, the digital rear mirror device 100 may be provided within the driver's field of view range. In various example embodiments, the digital rear mirror device 100 may provide a rear view of the vehicle. The digital rear mirror device 100 may operate in at least one of a mirror mode and a display mode. In the mirror mode, the digital rear mirror device 100 may directly illuminate the rear view of the vehicle through reflection of light. In the display mode, the digital rear mirror device 100 may provide the rear view of the vehicle by displaying a rear view video of the vehicle acquired by the camera device 10.

In some example embodiments, a video processing device (not shown) may be added between the digital rear mirror device 100 and the camera device 10. In this case, the video processing device may process video information acquired by the camera device 10 and may transmit the processed video information to the digital rear mirror device 100. In an example embodiment, the video processing device may store the video information in a memory within the video processing device. In another example embodiment, the video processing device may crop a portion of the video information. In still another example embodiment, the video processing device may enlarge at least a portion of the video information.

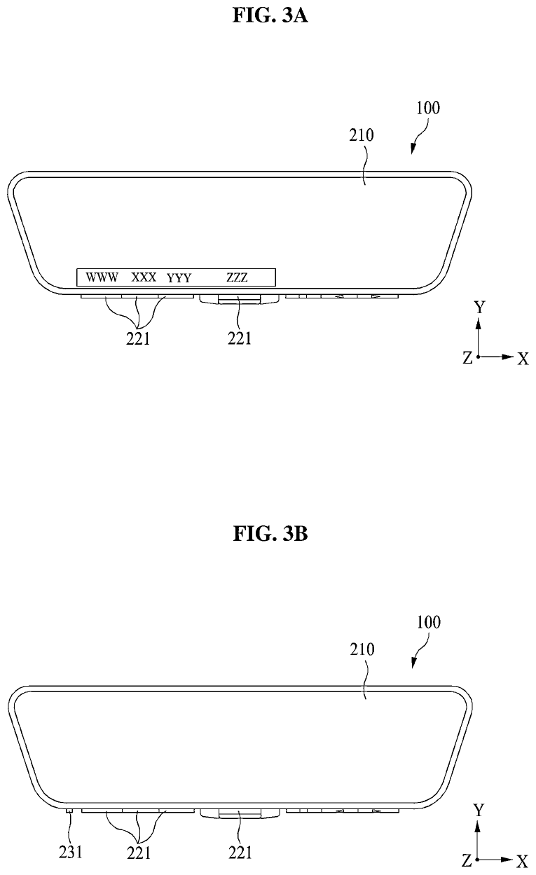

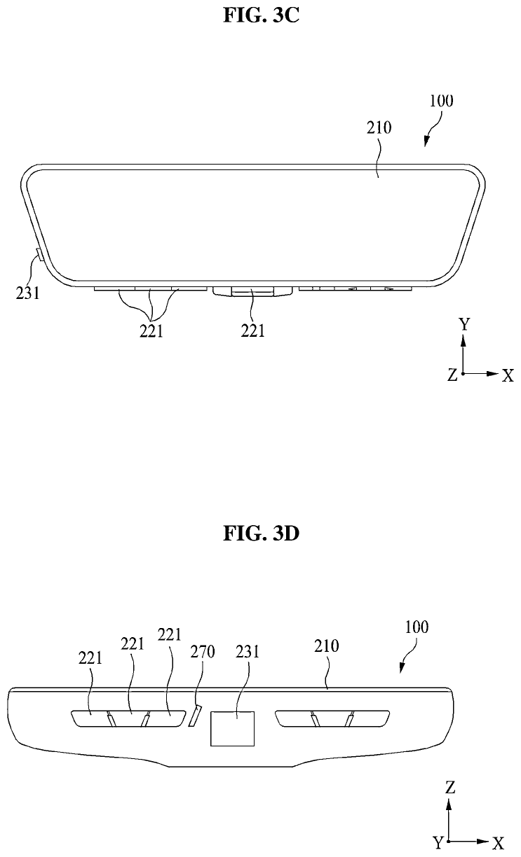

FIG. 2 is a block diagram illustrating a configuration of the digital rear mirror device 100 according to various example embodiments. FIGS. 3A, 3B, 3C, and 3D are views for describing examples of the digital rear mirror device 100 of FIG. 2. Here, FIGS. 3A, 3B, and 3C are front views of the digital rear mirror device 100, and FIG. 3D is a bottom view of the digital rear mirror device 100.

Referring to FIG. 2, the digital rear mirror device 100 may be mounted inside the vehicle with the camera device 10 and may be communicatively connected to the camera device 10. Here, the digital rear mirror device 100 may be provided within the driver's field of view range. In detail, the digital rear mirror device 100 may include at least one of a display module 210, an input module 220, a sensor module 230, a communication module 240, an interface module 250, a notification module 260, a memory 270, and a processor 280. In some example embodiments, at least one of the components of the digital rear mirror device 100 may be omitted, and at least one another component may be added. In some example embodiments, at least two of the components of the digital rear mirror device 100 may be implemented as a single integrated circuit. In an example embodiment, components of the digital rear mirror device 100 may be integrated into a single unit. In this case, the components of the digital rear mirror device 100 may be received within a single housing. In another example embodiment, the components of the digital rear mirror device 100 may be configured in at least two units in a distributed manner. In this case, at least the display module 210, the input module 220, the sensor module 230, and the notification module 260 may be accommodated within a single housing.

The display module 210 may be configured to provide the rear view of the vehicle. For example, the display module 210 may include at least one of a display, a hologram device, and a projector. In some example embodiments, the display module 210 may be implemented as a touchscreen by being assembled with the touch circuitry of the input module 220. The display module 210 may display the video information received from the processor 280. The display module 210 may have a display area with a predetermined resolution and size. As shown in FIGS. 3A, 3B, 3C, and 3D, the display module 210 may be accommodated within the housing such that the display area is exposed to the outside. In various example embodiments, the display module 210 may operate in at least one of the mirror mode and the display mode. In the mirror mode, the display module 210 may directly illuminate the rear view of the vehicle using reflection of light. In the display mode, the display module 210 may provide the rear view of the vehicle by displaying the rear view video received from the processor 280. In various example embodiments, the display module 210 may have an anti-glare function activated according to an applied voltage. To this end, the display module 210 may be implemented using, for example, an electronic chromic (EC) method or a liquid crystal (LC) method.

The input module 220 may input a signal to be used for at least one component of the digital rear mirror device 100. In various example embodiments, the input module 220 may include at least one button (which may also be referred to as key) 221. The button 221 may be arranged on at least one edge of the display module 210. For example, as shown in FIGS. FIGS. 3A, 3B, 3C, and 3D, the button 221 may be arranged on one edge of the display module 210 at a lower end of the digital rear mirror device 100. Here, the button 221 may include at least one of a physical button and a touch button. As shown in FIGS. 3A, 3B, 3C, and 3D, the physical button may have a pressable structure that protrudes from the surface of the housing. Although not illustrated, the touch button may have a flat structure relative to the surface of the housing. In some example embodiments, the input module 220 may further include at least one of a keyboard, a keypad, a mouse, a joystick, and a microphone. In some example embodiments, the input module 220 may further include at least one of a touch circuitry configured to be assembled with the display module 210.

The sensor module 230 may generate an electrical signal or a data value corresponding to an internal operation state (e.g., power or temperature) of the digital rear mirror device 100 or an external environmental state. In various example embodiments, the sensor module 230 may include at least one sensor 231. The sensor 231 may be arranged on at least one edge of the display module 210. Here, the sensor 231 may include at least one of a motion sensor (which may also be referred to as gesture sensor), a proximity sensor, and a touch sensor. For example, the motion sensor may recognize a motion of a hand, for example, a finger, of the user, the proximity sensor may recognize approach of the hand of the user, and the touch sensor may recognize contact of the finger of the user. As shown in FIG. 3B or 3C, the sensor 231 may be provided to be adjacent to the driver's seat on at least one of the bottom surface and the side surface of the digital rear mirror device 100. Alternatively, as shown in FIG. 3D, the sensor 231 may be provided on the bottom surface of the digital rear mirror device 100. In some example embodiments, the sensor module 230 may further include at least one of a global positioning system (PGS) sensor, a radar sensor, a light detection and ranging (LIDAR) sensor, a motion sensor, a gyro sensor, a barometric pressure sensor, a magnetic sensor, an acceleration sensor (e.g., G sensor), a proximity sensor, an infrared (IR) sensor, a biosignal sensor, a temperature sensor, a humidity sensor, and an illuminance sensor.

The communication module 240 may communicate with an external device. The communication module 240 may establish a communication channel between the digital rear mirror device 100 and the external device, and may communicate with the external device through the communication channel. Here, the external device may include at least one of a satellite, a base station, a server, and another electronic device. The communication module 240 may include at least one of a wired communication module and a wireless communication module. The wired communication module may be connected to the external device in a wired manner and may communicate with the external device in the wired manner through a connection terminal. The wireless communication module may include at least one of a near field communication module and a far field communication module. The near field communication module may communicate with the external device using a near field communication scheme. For example, the near field communication scheme may include at least one of Bluetooth, wireless fidelity (WiFi) direct, near field communication (NFC), and infrared data association (IrDA). The far field communication module may communicate with the external device using a far field communication scheme. Here, the far field communication module may communicate with the external device over a network. For example, the network may include at least one of a cellular network, the Internet, and a computer network such as a local area network (LAN) and a wide area network (WAN).

According to various example embodiments, at least one of the input module 220, the sensor module 230, and the communication module 240 may generate a user input. In an example embodiment, the input module 220 or an arbitrary sensor of the sensor module 230 may generate the user input based on a signal that is directly input from the user. In another example embodiment, the communication module 240 may generate the user input based on a signal that is input from another electronic device used by the user.

The interface module 250 may be provided for connection to the external device. In detail, the interface module 250 may support a designated protocol connectable to the external device in a wired or wireless manner. Here, the external device may include at least one of the vehicle and the camera device 10. In an example embodiment, in the case of communicating with the camera device 10 using an analog method, the interface module 250 may receive video information from the camera device 10 and may convert the same from an analog signal to digital data. In another example embodiment, in the case of communicating with the camera device 10 using a digital method, the interface module 250 may receive video information from the camera device 10 and may convert the same from serial data to parallel data. In this case, the interface module 250 may be implemented as a deserializer.

The notification module 260 may output a notification signal. The notification signal may include at least one of an audio signal and a light emitting signal. The notification module 260 may include an audio output module that outputs the audio signal, for example, at least one of a speaker and a receiver. In an example embodiment, the audio output module may include at least one voice coil that provides vibration to a diaphragm within the speaker and a magnet capable of forming a magnetic field. When current flows in the voice coil, the magnetic field formed in the voice coil may vibrate the voice coil through interaction with the magnetic field formed by the magnet. The diaphragm connected to the voice coil may vibrate based on vibration of the voice coil. The speaker may output the audio signal based on the vibration of the diaphragm. Meanwhile, the notification module 260 may include a light emitting module that outputs a light emitting signal, for example, a light emitting diode (LED) lamp. The notification module 260 may be provided at various locations in the digital rear mirror device 100. For example, as shown in FIG. 3D, the digital rear mirror device 100 may be provide on the bottom surface of the digital rear mirror device 100.

The memory 270 may store a variety of data used by at least one component of the digital rear mirror device 100. For example, the memory 270 may include at least one of a volatile memory and a non-volatile memory. Data may include at least one program and input data or output data related thereto. The program may be stored in the memory 270 as software including at least one instruction, and, for example, may include at least one of an operating system (OS), middleware, and an application. The memory 270 may include at least one of a first memory embedded in the digital rear mirror device 100 and a second memory detachably provided to the digital rear mirror device 100. In various example embodiments, the memory 270 may store an operation function assigned to the corresponding button 221 and identification information thereof in response to the button 221. In various example embodiments, the memory 270 may store an operation function assigned to a corresponding signal in response to the signal detected through the sensor 231.

The processor 280 may control at least one component of the digital rear mirror device 100 by executing the program of the memory 270. Through this, the processor 280 may perform data processing or arithmetic operations. Here, the processor 280 may execute the instructions stored in the memory 270.

In various example embodiments, the processor 280 may provide identification information on the operation function assigned to the button 221 at a location corresponding to the button 221 through at least a portion of the display module 210 while providing the rear view of the vehicle through the display module 210. Here, the processor 280 may display the identification information in an on screen display (OSD) manner such that the identification information is overlappingly displayed in the rear view. For example, as shown in FIG. 3A, the processor 280 may display the identification information on the button 221 to be adjacent to the button 221. Here, the identification information may be expressed using at least one of image, shape, symbol, and text. For example, the operation function may include at least one of a power (on/off) function, a setting function, and a tilt (up/down/left/right) function.

In some example embodiments, the processor 280 may display identification information on the changed operation function in response to the button 221 through at least a portion of the display module 210 while changing the operation function assigned to the button 221. In addition, the processor 280 allows the memory 270 to store the changed operation function and identification information thereon in response to the button 221.

In an example embodiment, the processor 280 may continuously display the identification information on the button 221 while the digital rear mirror device 100 is turned on. In another example embodiment, the processor 280 may display the identification information on the button 221 based on a signal detected through the sensor 231 as shown in FIG. 3B, 3C, or 3D. In this case, the processor 280 may no longer display the identification information on the button 221 according to a predetermined condition through the display module 210. For example, when the button 221 is not selected for a predetermined period of time while displaying the identification information on the button 221, or when the operation function assigned to the button 221 is not changed, the processor 280 may remove the identification information on the button 221 from the display module 210. As another example, the processor 280 may remove the identification information on the button 221 from the display module 210 based on a signal detected through the sensor 231 while displaying the identification information on the button 221.

In various example embodiments, while providing the rear view of the vehicle through the display module 210, the processor 280 may switch the display module 210 based on the signal detected through the sensor 231 as shown in FIG. 3B, 3C, or 3D. For example, when the signal is received from the sensor 231, the processor 280 may output a notification signal through the notification module 260. In an example embodiment, the processor 280 may adjust an angle of the rear view provided through the display module 210. In another example embodiment, the processor 280 may activate the anti-glare function for the display module 210. Here, the processor 280 may activate the anti-glare function by adjusting the voltage applied to the display module 210. In still another example embodiment, the processor 280 may switch the display module 210 between the mirror mode and the display mode. The processor 280 may return the display module 210 If a predetermined period of time elapses after switching the display module 210, or may return the display module 210 based on the signal detected through the sensor 231.

In some example embodiments, the processor 280 may differently switch the display module 210 depending on signals. In an example embodiment, when the sensor 231 is a motion sensor, different types of motions may be distinguished using different signals, or different numbers of repetitions for the same type of motion may be distinguished using different signals. In another example embodiment, when the sensor 231 is a proximity sensor, proximities of different durations may be distinguished using different signals, or different numbers of repetitions for proximity of the same duration may be distinguished using different signals. In still another example embodiment, when the sensor 231 is a touch sensor, different patterns of touches may be distinguished using different signals, different numbers of repetitions for touch may be distinguished using different signals, or different durations of touches may be distinguished using different signals.

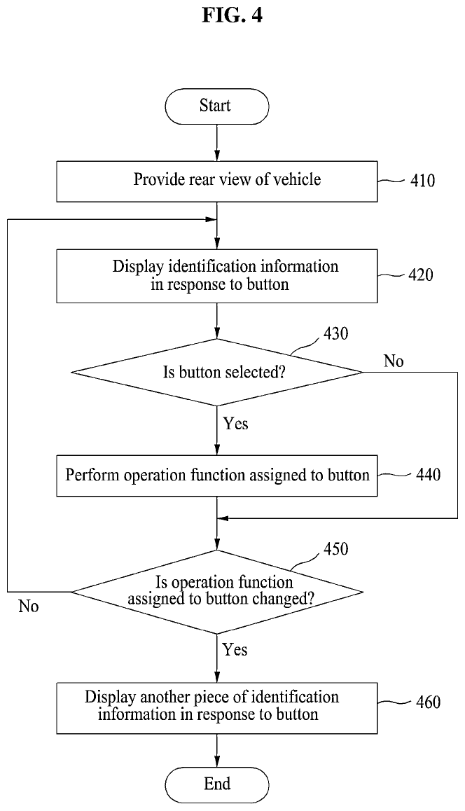

FIG. 4 is a flowchart illustrating an operating method of the digital rear mirror device 100 according to a first example embodiment.

Referring to FIG. 4, in operation 410, the digital rear mirror device 100 may provide a rear view of a vehicle. In detail, the processor 280 may provide the rear view of the vehicle through the display module 210. Here, the processor 280 may operate the display module 210 in at least one of a mirror mode and a display mode. In the mirror mode, the display module 210 may directly illuminate the rear view of the vehicle using reflection of light. In the display mode, the processor 280 may provide the rear view of the vehicle by acquiring a rear view video of the vehicle from the camera device 10 through the interface module 250 and by displaying the rear view video through the display module 210.

Then, in operation 420, the digital rear mirror device 100 may display identification information on an operation function assigned to the button 221 in response to the button 221. In detail, the processor 280 may display identification information on the button 221 at a location corresponding to the button 221 through at least a portion of the display module 210 while providing the rear view of the vehicle through the display module 210. The memory 270 may store the operation function assigned to the button 221 and identification information thereon in response to the button 221, and the processor 280 may detect and display the identification information on the button 221 from the memory 270. Here, the processor 280 may display the identification information in an OSD manner such that the identification information may be overlappingly displayed in the rear view. For example, the processor 280 may display identification information on the button 221 to be adjacent to the button 221 as shown in FIG. 3A. Here, the identification information may be expressed using at least one of image, shape, symbol, and text. For example, the operation function may include at least one of a power (on/off) function, a setting function, and a tilt (up/down/left/right) function.

In an example embodiment, while the digital rear mirror device 100 is turned on, the processor 280 may continuously display identification information on the button 221. In another example embodiment, for example, the processor 280 may display identification information on the button 221 based on a signal detected through the sensor 231 as shown in FIG. 3B, 3C, or 3D.

While identification information on the button 221 is being displayed, the button 221 may be selected in operation 430. In detail, the user may select the button 221 with reference to the identification information, which may be detected by the processor 280. When the button 221 is a physical button, the user may select the button 221 by pressing the button 221. When the button 221 is a touch button, the user may select the button 221 by touching the button 221. In response thereto, the digital rear mirror device 100 may perform the operation function assigned to the button 221 in operation 440. In detail, the processor 280 may detect, from the memory 270, and perform the operation function assigned to the button 221.

While displaying identification information on the button 221, the digital rear mirror device 100 may change the operation function assigned to the button 221 in operation 450. In detail, a user input for changing the operation function assigned to the button 221 is generated by the user and, based thereon, the processor 280 may change the operation function assigned to the button 221. In response thereto, the digital rear mirror device 100 may display another piece of identification information corresponding to the button 221 in operation 460. In detail, while changing the operation function assigned to the button 221, the processor 280 may display identification information on the changed operation function in response to the button 221 through at least a portion of the display module 210. In addition, the processor 280 allows the memory 270 to store the changed operation function and identification information thereon in response to the button 221.

In an example embodiment, when the display module 210 is implemented as a touchscreen by being assembled with the touch circuitry of the input module 220, the user may generate the user input for changing the operation function assigned to the button 221 through the touchscreen. That is, when a plurality of buttons 221 including the first button 221 and the second button 221 is present, first identification information of the first button 221 may be moved to the second button 221 on the touchscreen by the user. In response thereto, the processor 280 may exchange operation functions assigned to the first button 221 and the second button 221, respectively, while moving second identification information of the second button 221 to the first button 221. In another example embodiment, when one of the plurality of buttons 221 is the setting button 221, the user may generate the user input for changing an operation function assigned to another one of the buttons 221 through the setting button 221. That is, the other one is selected from among the buttons 221 based on a selection of the setting button 221, and the operation function to be assigned to the selected button 221 may be selected. In response thereto, the processor 280 may change the operation function assigned to the other one of the buttons 221 and may display identification information on the changed operation function in response to the other one of the buttons 221.

In an example embodiment, for example, when displaying identification information on the button 221 based on a signal detected through the sensor 231 as shown in FIG. 3B, 3C, or 3D, the processor 280 may no longer display identification information on the button 221 according to a predetermined condition through the display module 210. For example, when the button 221 is not selected during a predetermined period of time or when the operation function assigned to the button 221 is not changed while displaying identification information on the button 221, the processor 280 may remove identification information on the button 221 from the display module 210. As another example, the processor 280 may remove identification information on the button 221 from the display module 210 based on a signal detected through the sensor 231, while displaying identification information on the button 221.

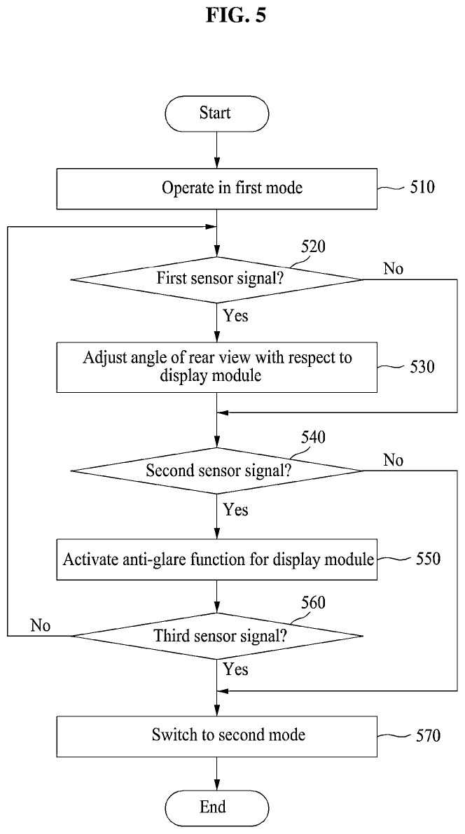

FIG. 5 is a flowchart illustrating an operating method of the digital rear mirror device 100 according to a second example embodiment.

Referring to FIG. 5, in operation 510, the digital rear mirror device 100 may operate in a first mode. In detail, the processor 280 may operate the display module 210 in the first mode and may provide a rear view of a vehicle through the display module 210. The processor 280 may provide the rear view at a predetermined angle. Here, the corresponding angle may be preset by the user. Here, the first mode may be one of a mirror mode and a display mode.

When the first mode is the mirror mode, the display module 210 may directly illuminate the rear view of the vehicle using reflection of light. Here, the digital rear mirror device 100 may be provided with a posture at a predetermined angle, and the display module 210 may provide the rear view at the corresponding angle. When the first mode is the display mode, the processor 280 may provide the rear view of the vehicle by acquiring a rear view video of the vehicle from the camera device 10 through the interface module 250 and by displaying the rear view video through the display module 210. In an example embodiment, the camera device 10 may capture the rear view video of the vehicle, may detect a partial video at a location corresponding to the predetermined angle from the rear view video, and may transmit the partial area to the digital rear mirror device 100. Therefore, the processor 280 may provide the rear view at the corresponding angle by displaying the partial video. In another example embodiment, the camera device 10 may capture the rear view video of the vehicle and may transmit the same to the digital rear mirror device 100. Therefore, the processor 280 may provide the rear view at the corresponding angle by detecting and displaying the partial video at a location corresponding to the predetermined angle from the rear view video.

While operating in the first mode, the digital rear mirror device 100 may detect a first sensor signal in operation 520. In detail, while providing the rear view of the vehicle through the display module 210, the processor 280 may detect the first sensor signal through the sensor 231 as shown in FIG. 3B, 3C, or 3D. Here, the first sensor signal may be detected from a predetermined type of motion or the number of repetitions of thereof through a motion sensor, may be detected from proximity of a predetermined duration or the number of repetitions thereof trough a proximity sensor, or may be detected from a predetermined pattern of touch or the number of repetitions thereof or a touch of a predetermined duration through a touch sensor. In response thereto, the digital rear mirror device 100 may adjust the angle of the rear view with respect to the display module 210 in operation 530. In detail, the processor 280 may adjust the angle of the rear view provided through the display module 210 to another angle. Here, the other angle may be preset by the user.

When the first mode is the mirror mode, the processor 280 may change the posture of the digital rear mirror device 100 to the other angle and accordingly, the display module 210 may provide the rear view at the changed angle. When the first mode is the display mode, the processor 280 may change the location at which the partial video is detected from the rear view video captured by the camera device 10 to a different angle and accordingly, the display module 210 may provide the rear view at the changed angle. In an example embodiment, the camera device 10 may capture the rear view video of the vehicle, may detect the partial video at the changed angle from the rear view video, and may transmit the partial video to the digital rear mirror device 100. Therefore, the processor 280 may provide the rear view at the changed angle by displaying the partial video. In another example embodiment, the camera device 10 may capture the rear view video of the video and may transmit the same to the digital rear mirror device 100. Therefore, the processor 280 may provide the rear view at the changed angle by detecting and displaying the partial video at the changed angle from the rear view video.

While operating in the first mode, the digital rear mirror device 100 may detect a second sensor signal in operation 540. In detail, while providing the rear view of the vehicle through the display module 210, the processor 280 may detect the second sensor signal through the sensor 231 as shown in FIG. 3B, 3C, or 3D. Here, the second sensor signal differs from the first sensor signal, and may be detected from a predetermined type of motion or the number of repetitions of thereof through a motion sensor, may be detected from proximity of a predetermined duration or the number of repetitions thereof trough a proximity sensor, or may be detected from a predetermined pattern of touch or the number of repetitions thereof or a touch of a predetermined duration through a touch sensor. In response thereto, the digital rear mirror device 100 may activate an anti-glare function for the display module 210 in operation 550. In detail, the processor 280 may activate the anti-glare function by adjusting at least one of reflectance or transmittance of the display module 210. In some example embodiments, the processor 280 may activate the anti-glare function by adjusting voltage applied to the display module 210. When the display module 210 is implemented using an electronic chromic method, a color change may occur in the display module 210 as the applied voltage is adjusted and accordingly, the anti-glare function may be activated. When the display module 210 is implemented using a liquid crystal method, a change in liquid crystal arrangement may occur in the display module 210 as the applied voltage is adjusted and accordingly, the anti-glare function may be activated.

While operating in the first mode, the digital rear mirror device 100 may detect a third sensor signal in operation 560. In detail, while providing the rear view of the vehicle through the display module 210, the processor 280 may detect the third sensor signal through the sensor 231 as shown in FIG. 3B, 3C, or 3D. Here, the third signal differs from the first sensor signal and the second sensor signal and may be detected from a predetermined type of motion or the number of repetitions of thereof through a motion sensor, may be detected from proximity of a predetermined duration or the number of repetitions thereof trough a proximity sensor, or may be detected from a predetermined pattern of touch or the number of repetitions thereof or a touch of a predetermined duration through a touch sensor. In response thereto, the digital rear mirror device 100 may switch to a second mode in operation 570. In detail, the processor 280 may operate the display module 210 in the second mode and may provide the rear view of the vehicle through the display module 210. Here, the processor 280 may provide the rear view at a predetermined angle. Here, the corresponding angle may be preset by the user. Here, the second mode differs from the first mode and may be the other one between the mirror mode and the display mode.

According to the present disclosure, the digital rear mirror device 100 may continuously provide the rear view of the vehicle. In detail, the digital rear mirror device 100 may provide the rear view of the vehicle by directly illuminating the rear view of the vehicle through reflection of light in the mirror mode and by displaying the rear view video of the vehicle acquired by the camera device 10 in the display mode. Accordingly, a driver of the vehicle may keep an eye on the rear while looking ahead during driving.

According to a first feature, the digital rear mirror device 100 may help the user intuitively identify the purpose of the button 221 and enables a button-based easy operation in the digital rear mirror device 100 by displaying identification information at least one button 221 while providing the rear view of the vehicle through the display module 210. According to a second feature, the digital rear mirror device 100 enables a sensor-based easy operation in the digital rear mirror device 100 by switching the display module 210 based on a signal detected through at least one sensor 231. Such features allow the driver of the vehicle to easily operate the digital rear mirror device 100 while driving. In addition, such features may reduce a size of the digital rear mirror device 100 that includes at least one of a button and a sensor and may simplify the structure, which may lead to reducing the manufacture cost of the digital rear mirror device 100.

In short, the present disclosure provides the digital rear mirror device 100 for easy operation based on the button 221 or the sensor 231 and an operating method of the same.

In the present disclosure, the digital rear mirror device 100 of a vehicle may include the display module 210 configured to provide a rear view of the vehicle, the input module 220 including at least one button 221 arranged on at least one edge of the display module 210, and the processor 280 configured to connect to each of the display module 210 and the input module 220 and to display identification information on an operation function assigned to the button 221 in response to the button 221 through the display module 210.

According to various example embodiments, the button 221 may include at least one of a physical button and a touch button.

According to various example embodiments, the processor 280 may be configured to change the operation function assigned to the button 221 and to display identification information on the changed operation function in response to the button 221.

According to various example embodiments, the input module 220 may include the plurality of buttons 221 and a touch circuitry assembled with the display module 210, and when the buttons 221 include the first button 221 and the second button 221, the processor 280 may be configured to, when first identification information of the first button 221 moves to the second button 221 through the touch circuitry, move second identification information of the second button 221 to the first button 221 and to exchange operation functions assigned to the first button 221and the second button 221, respectively.

According to various example embodiments, when the input module 220 includes the plurality of buttons 221 and one of the buttons 221 is the setting button 221, the processor 280 may be configured to change an operation function assigned to another one of the buttons 221 based on a selection of the setting button 221 and to display identification information on the changed operation function in response to the other one of the buttons 221.

According to various example embodiments, the digital rear mirror device 100 may further include at least one sensor 231 arranged on at least one edge of the display module 210.

According to various example embodiments, the processor 280 may be configured to display the identification information based on a signal detected through the sensor 231.

According to various example embodiments, the processor 280 may be configured to switch the display module 210 based on a signal detected through the sensor 231.

In the present disclosure, the digital rear mirror device 100 of a vehicle may include the display module 210 configured to provide a rear view of the vehicle, at least one sensor 231 arranged on at least one edge of the display module 210, and the processor 280 configured to connect to each of the display module 210 and the sensor 231 and to switch the display module 210 based on a signal detected through the sensor 231.

According to various example embodiments, the processor 280 may be configured to adjust an angle of the rear view provided through the display module 210 based on the signal.

According to various example embodiments, the processor 280 may be configured to activate an anti-glare function for the display module 210 based on the signal.

According to various example embodiments, the processor 280 may be configured to activate the anti-glare function by adjusting voltage applied to the display module 210.

According to various example embodiments, the processor 280 may be configured to switch the display module 210 between a mirror mode for directly illuminating the rear view and a display mode for providing the rear view by displaying a rear view video of the vehicle based on the signal.

According to various example embodiments, the sensor 231 may include at least one of a motion sensor, a proximity sensor, and a touch sensor.

According to various example embodiments, the processor 280 may be configured to return the display module 210 if a predetermined period of time elapses after switching the display module 210, or to return the display module 210 based on the signal detected through the sensor 231.

In the present disclosure, an operating method of the digital rear mirror device 100 of a vehicle may include providing a rear view of the vehicle through the display module 210 (operation 410), and, in response to at least one button 221 arranged on at least one edge of the display module 210, displaying identification information on an operation function assigned to the button 221 through the display module 210 (operation 420).

According to various example embodiments, the button 221 may include at least one of a physical button and a touch button.

According to various example embodiments, the operating method of the digital rear mirror device 100 may further include changing the operation function assigned to the button 221 and displaying identification information on the changed operation function in response to the button 221 (operations 450 and 460).

According to various example embodiments, when the plurality of buttons 221 is arranged on at least one edge of the display module 210 and the buttons 221 include the first button 221 and the second button 221, the displaying the identification information on the changed operation function (operations 450 and 460) may include, when first identification information of the first button 221 moves to the second button 221 through a touch circuitry assembled with the display module 210, moving second identification information of the second button 221 to the first button 221 and exchanging operation functions assigned to the first button 221 and the second button 221, respectively.

According to various example embodiments, when the plurality of buttons 221 is arranged on the edge of the display module 210, the displaying the identification information on the changed operation function (operations 450 and 460) may include changing an operation function assigned to another one of the buttons 221 based on a selection of the setting button 221 and displaying identification information on the changed operation function in response to the other one of the buttons 221.

According to various example embodiments, at least one sensor 231 may be arranged on at least one edge of the display module 210.

According to various example embodiments, the displaying the identification information (operation 420) may include displaying the identification information based on a signal detected through the sensor 231.

In the present disclosure, the operating method of the digital rear mirror device 100 may further include switching the display module 210 based on a signal detected through the sensor 231.

According to various example embodiments, an operating method of the digital rear mirror device 100 of a vehicle may include providing a rear view of the vehicle through the display module 210 (operation 510), and switching the display module 210 based on a signal detected through at least one sensor 231 arranged on at least one edge of the display module 210.

According to various example embodiments, the switching the display module 210 may include adjusting an angle of the rear view provided through the display module 210 based on the signal (operations 520 and 530).

According to various example embodiments, the switching the display module 210 may include activating an anti-glare function for the display module 210 based on the signal (operations 540 and 550).

According to various example embodiments, the activating the anti-glare function (operations 540 and 550) may include activating the anti-glare function by adjusting voltage applied to the display module 210.

According to various example embodiments, the switching the display module 210 may include switching the display module 210 between a mirror mode for directly illuminating the rear view and a display mode for providing the rear view by displaying a rear view video of the vehicle based on the signal (operations 560 and 570).

According to various example embodiments, the sensor 231 may include at least one of a motion sensor, a proximity sensor, and a touch sensor.

According to various example embodiments, the operating method of the digital rear mirror device 100 may further include at least one of returning the display module 210 if a predetermined period of time elapses, and returning the display module 210 based on another signal detected through the sensor 231.

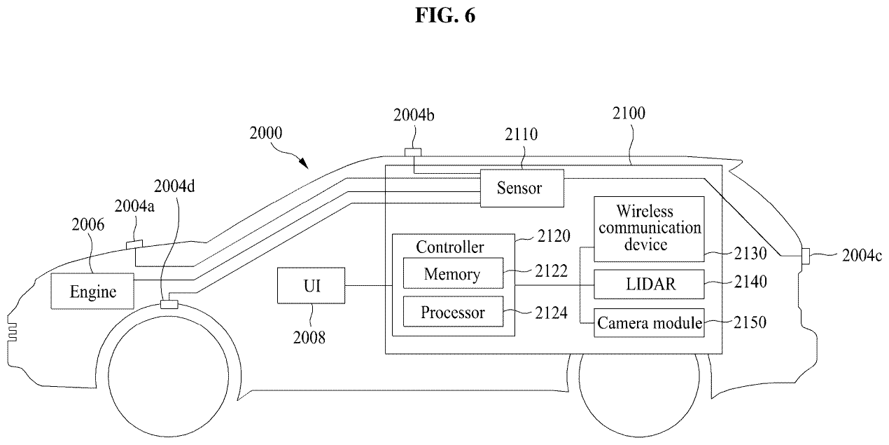

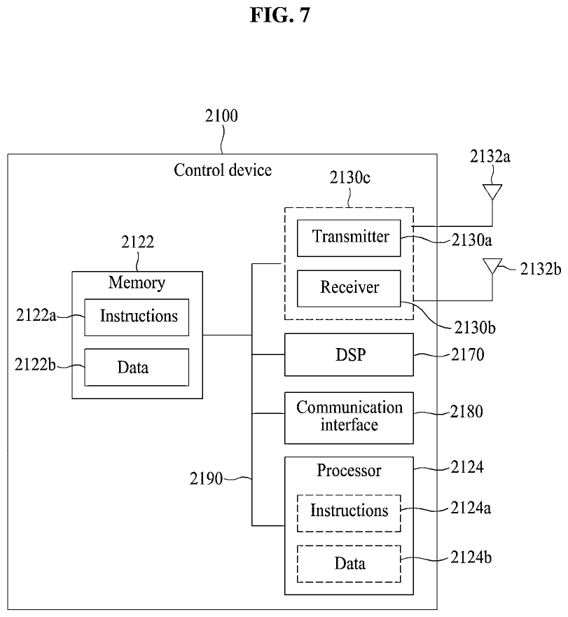

FIG. 6 is a block diagram illustrating a vehicle 2000 to which the digital rear mirror device 100 is mounted according to various example embodiments. FIG. 7 is a block diagram illustrating a control device 2100 of the vehicle of FIG. 6.

Referring to FIGS. 6 and 7, the digital rear mirror device 100 according to various example embodiments may be mounted to the vehicle 2000 and the vehicle 2000 may include the control device 2100. Here, the vehicle 2000 may be an autonomous vehicle. In some example embodiments, at least one component of the digital rear mirror device 100 may be integrated into at least one component of the control device 2100.

The control device 2100 may include a controller 2120 that includes a memory 2122 and a processor 2124, a sensor 2110, a wireless communication device 2130, a light detection and ranging (LIDAR) device 2140, and a camera module 2150.

The controller 2120 may be configured at a time of manufacture by a manufacturing company of the vehicle or may be additionally configured to perform an autonomous driving function after manufacture. Alternatively, a configuration to continuously perform an additional function by upgrading the controller 2120 configured at the time of manufacture may be included.

The controller 2120 may forward a control signal to the sensor 2110, an engine 2006, a user interface (UI) 2008, the wireless communication device 2130, the LIDAR device 2140, and the camera module 2150 included as other components in the vehicle. Also, although not illustrated, the controller 2120 may forward a control signal to an acceleration device, a braking system, a steering device, or a navigation device associated with driving of the vehicle.

The controller 2120 may control the engine 2006. For example, the controller 2120 may sense a speed limit of a road on which the vehicle 2000 is driving and may control the engine 2006 such that a driving speed may not exceed the speed limit, or may control the engine 2006 to increase the driving speed of the vehicle 2000 within the range of not exceeding the speed limit. Additionally, when sensing modules 2004a, 2004b, 2004c, and 2004d sense an external environment of the vehicle and forward the same to the sensor 2110, the controller 2120 may receive external environment information, may generate a signal for controlling the engine 2006 or a steering device (not shown), and thereby control driving of the vehicle.

When another vehicle or an obstacle is present in front of the vehicle, the controller 2120 may control the engine 2006 or the braking system to decrease the driving speed and may also control a trajectory, a driving route, and a steering angle in addition to the speed. Alternatively, the controller 2120 may generate a necessary control signal according to recognition information of other external environments, such as, for example, a driving lane, a driving signal, etc., of the vehicle, and may control driving of the vehicle.

The controller 2120 may also control driving of the vehicle by communicating with a nearby vehicle or a central server in addition to autonomously generating the control signal and by transmitting an instruction for controlling peripheral devices based on the received information.

Further, if a location or an angle of view of the camera module 2150 is changed, it may be difficult for the controller 2120 to accurately recognize a vehicle or a lane. To prevent this, the controller 2120 may generate a control signal for controlling a calibration of the camera module 2150. Therefore, the controller 2120 may generate a calibration control signal for the camera module 2150 and may continuously maintain a normal mounting location, direction, angle of view, etc., of the camera module 2150 regardless of a change in a mounting location of the camera module 2150 by a vibration or an impact occurring due to a motion of the autonomous vehicle 2000. When prestored information on an initial mounting location, direction, and angle of view of the camera module 2120 differs from information on the initial mounting location, direction, and angle of view of the camera module 2120 that are measured during driving of the autonomous vehicle 2000 by a threshold or more, the controller 2120 may generate a control signal for performing calibration of the camera module 2120.

The controller 2120 may include the memory 2122 and the processor 2124. The processor 2124 may execute software stored in the memory 2122 in response to the control signal of the controller 2120. In detail, the controller 2120 may store, in the memory 2122, data and instructions for detecting a visual field view from a rear view video of the vehicle 2000, and the instructions may be executed by the processor 2124 to perform one or more methods disclosed herein.

Here, the memory 2122 may be stored in a recording medium executable at the non-volatile processor 2124. The memory 2122 may store software and data through an appropriate external device. The memory 2122 may include random access memory (RAM), read only memory (ROM), hard disk, and a memory device connected to a dongle.

The memory 2122 may at least store an operating system (OS), a user application, and executable instructions. The memory 2122 may store application data and arrangement data structures.

The processor 2124 may be a controller, a microcontroller, or a state machine as a microprocessor or an appropriate electronic processor.

The processor 2124 may be configured as a combination of computing devices. The computing device may be configured as a digital signal processor, a microprocessor, or an appropriate combination thereof.

Also, the control device 2100 may monitor internal and external features of the vehicle 2000 and may detect a state of the vehicle 2000 using at least one sensor 2110.

The sensor 2110 may include at least one sensing module 2004. The sensing module 2004 may be implemented at a specific location of the vehicle 2000 depending on a sensing purpose. The sensing module 2004 may be provided in a lower portion, a rear end, a front end, an upper end, or a side end of the vehicle 2000 and may be provided to an internal part of the vehicle, a tier, and the like.

Through this, the sensing module 2004 may sense driving information, such as the engine 2006, a tier, a steering angle, a speed, a vehicle weight, and the like, as internal vehicle information. Also, the at least one sensing module 2004 may include an acceleration sensor (2110), a gyroscope, an image sensor (2110), a radar, an ultrasound sensor, a LIDAR sensor, and the like, and may sense motion information of the vehicle 2000.

The sensing module 2004 may receive specific data, such as state information of a road on which the vehicle 2000 is present, nearby vehicle information, and an external environmental state such as weather, as external information, and may sense a vehicle parameter according thereto. The sensed information may be stored in the memory 2122 temporarily or in long-term depending on purposes.

The sensor 2110 may integrate and collect information of the sensing modules 2004 for collecting information generated inside and on outside the vehicle 2000.

The control device 2100 may further include the wireless communication device 2130.

The wireless communication device 2130 is configured to implement wireless communication between the vehicles 2000. For example, the wireless communication device 2130 enables the vehicles 2000 to communicate with a mobile phone of a user, another wireless communication device 2130, another vehicle, a central device (traffic control device), a server, and the like. The wireless communication device 2130 may transmit and receive a wireless signal according to a connection communication protocol. A wireless communication protocol may be WiFi, Bluetooth, Long-Term Evolution (LTE), code division multiple access (CDMA), wideband code division multiple access (WCDMA), and global systems for mobile communications (GSM). However, it is provided as an example only and the wireless communication protocol is not limited thereto.

Also, the vehicle 2000 may implement vehicle-to-vehicle (V2V) communication through the wireless communication device 2130. That is, the wireless communication device 2130 may perform communication with another vehicle and other vehicles on the roads through the V2V communication. The vehicle 2000 may transmit and receive information, such as driving warnings and traffic information, through the V2V communication and may also request another vehicle for information or may receive a request from the other vehicle. For example, the wireless communication device 2130 may perform the V2V communication using a dedicated short-range communication (DSRC) device or a celluar-V2V (CV2V) device. Also, in addition to the V2V communication, vehicle-to-everything (V2X) communication, communication between the vehicle and another object (e.g., electronic device carried by pedestrian), may be implemented through the wireless communication device 2130.

Also, the control device 2100 may include the LIDAR device 2140. The LIDAR device 2140 may detect an object around the vehicle 2000 during an operation, based on data sensed using a LIDAR sensor. The LIDAR device 2140 may transmit detection information to the controller 2120, and the controller 2120 may operate the vehicle 2000 based on the detection information. For example, when the detection information includes a vehicle ahead driving at a low speed, the controller 2120 may instruct the vehicle to decrease a speed through the engine 2006. Alternatively, the controller 2120 may instruct the vehicle to decrease a speed based on a curvature of a curve the vehicle enters.

The control device 2100 may further include the camera module 2150. The controller 2120 may extract object information from an external image captured from the camera module 2150, and may process the extracted object information using the controller 2120.

Also, the control device 2100 may further include imaging devices configured to recognize an external environment. In addition to the LIDAR device 2140, a radar, a GPS device, a driving distance measurement device (odometry), and other computer vision devices may be used. Such devices may selectively or simultaneously operate depending on necessity, thereby enabling further precise sensing.

The vehicle 2000 may further include the user interface (UI) 2008 for a user input to the control device 2100. The user interface 2008 enables the user to input information through appropriate interaction. For example, the user interface 2008 may be configured as a touchscreen, a keypad, and a control button. The user interface 2008 may transmit an input or an instruction to the controller 2120, and the controller 2120 may perform a vehicle control operation in response to the input or the instruction.

Also, the user interface 2008 may enable communication between an external device of the vehicle 2000 and the vehicle 2000 through the wireless communication device 2130. For example, the user interface 2008 may enable interaction with a mobile phone, a tablet, or other computer devices.

Further, although the example embodiment describes that the vehicle 2000 includes the engine 2006, it is provided as an example only. The vehicle 2000 may include a different type of a propulsion system. For example, the vehicle 2000 may run with electric energy, and may run with hydrogen energy or through a hybrid system with a combination thereof. Therefore, the controller 2120 may include a propulsion mechanism according to the propulsion system of the vehicle 2000 and may provide a control signal according thereto to each component of the propulsion mechanism.

Hereinafter, a configuration of the control device 2100 of the vehicle 2000 is described with reference to FIG. 7.

The control device 2100 may include the processor 2124. The processor 2124 may be a general-purpose single or multi-chip microprocessor, a dedicated microprocessor, a microcontroller, a programmable gate array, and the like. The processor may also be referred to as a central processing unit (CPU). Also, the processor 2124 may be a combination of a plurality of processors.

The control device 2100 also includes the memory 2122. The memory 2122 may be any electronic component capable of storing electronic information. The memory 2122 may include a combination of memories 2122 in addition to a unit memory.

According to various example embodiments, data and instructions 2122a of the vehicle 2000 may be stored in the memory 2122. When the processor 2124 executes the instructions 2122a, the instructions 2122a and a portion or all of the data 2122b required to perform command may be loaded to the processor 2124 (2124a and 2124b).

The control device 2100 may include a transmitter 2130a and a receiver 2130b, or a transceiver 2130c, to allow transmission and reception of signals. One or more antennas 2132a and 2132b may be electrically connected to the transmitter 2130a and the receiver 2130b, or the transceiver 2130c, and may include additional antennas.

The control device 2100 may include a digital signal processor (DSP) 2170, and may control the vehicle to quickly process a digital signal through the DSP 2170.

The control device 2100 may also include a communication interface 2180. The communication interface 2180 may include one or more ports and/or communication modules configured to connect other devices to the control device 2100. The communication interface 2180 may enable interaction between the user and the control device 2100.

Various components of the control device 2100 may be connected through one or more buses 2190, and the buses 2190 may include a power bus, a control signal bus, a state signal bus, and a database bus. The components may forward mutual information through the buses 2190 under control of the processor 2124 and may perform desired functions.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of record methods or storage methods in which a single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

The term “module” used herein may include a unit configured as hardware, software, or firmware, and may be interchangeably used with the terms, for example, “logic,” “logic block,” “part,” “circuit,” etc. The module may be an integrally configured part, a minimum unit that performs one or more functions, or a portion thereof. For example, the module may be configured as an application-specific integrated circuit (ASIC).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. A digital rear mirror device of a vehicle, comprising:
a display module configured to provide a rear view of the vehicle;
an input module including at least one button arranged on at least one edge of the display module; and
a processor configured to connect to each of the display module and the input module and to display identification information on an operation function assigned to the button in response to the button through the display module.

2. The digital rear mirror device of claim 1, wherein the button includes at least one of a physical button and a touch button.

3. The digital rear mirror device of claim 1, wherein the processor is configured to change the operation function assigned to the button and to display identification information on the changed operation function in response to the button.

4. The digital rear mirror device of claim 3, wherein the input module includes a plurality of buttons and a touch circuitry assembled with the display module, and the buttons include a first button and a second button, and
the processor is configured to, when first identification information of the first button moves to the second button through the touch circuitry, move second identification information of the second button to the first button and to exchange operation functions assigned to the first button and the second button, respectively.

5. The digital rear mirror device of claim 3, wherein the input module includes a plurality of buttons, and one of the buttons is a setting button, and
the processor is configured to change an operation function assigned to another one of the buttons based on a selection of the setting button and to display identification information on the changed operation function in response to the other one of the buttons.

6. The digital rear mirror device of claim 1, further comprising:
at least one sensor arranged on at least one edge of the display module.

7. The digital rear mirror device of claim 6, wherein the processor is configured to display the identification information based on a signal detected through the sensor.

8. The digital rear mirror device of claim 6, wherein the processor is configured to switch the display module based on a signal detected through the sensor.

9. The digital rear mirror device of claim 8, wherein the processor is configured to,
adjust an angle of the rear view provided through the display module based on the signal,
activate an anti-glare function for the display module based on the signal, or
switch the display module between a mirror mode for directly illuminating the rear view through reflection of light and a display mode for providing the rear view by displaying a rear view video of the vehicle based on the signal, and
the processor is configured to return the display module if a predetermined period of time elapses after switching the display module, or to return the display module based on the signal detected through the sensor.

10. The digital rear mirror device of claim 6, wherein the sensor includes at least one of a motion sensor, a proximity sensor, and a touch sensor.

11. An operating method of a digital rear mirror device of a vehicle, the operating method comprising:
providing a rear view of the vehicle through a display module; and
in response to at least one button arranged on at least one edge of the display module, displaying identification information on an operation function assigned to the button through the display module.

12. The operating method of claim 11, wherein the button includes at least one of a physical button and a touch button.

13. The operating method of claim 11, further comprising:
changing the operation function assigned to the button and displaying identification information on the changed operation function in response to the button.

14. The operating method of claim 13, wherein a plurality of buttons is arranged on at least one edge of the display module, and the buttons include a first button and a second button, and
the displaying the identification information on the changed operation function comprises, when first identification information of the first button moves to the second button through a touch circuitry assembled with the display module, moving second identification information of the second button to the first button and exchanging operation functions assigned to the first button and the second button, respectively.

15. The operating method of claim 13, wherein a plurality of buttons is arranged on the edge of the display module, and
the displaying the identification information on the changed operation function comprises changing an operation function assigned to another one of the buttons based on a selection of a setting button and displaying identification information on the changed operation function in response to the other one of the buttons.

16. The operating method of claim 11, wherein at least one sensor is arranged on at least one edge of the display module.

17. The operating method of claim 16, wherein the displaying the identification information comprises displaying the identification information based on a signal detected through the sensor.

18. The operating method of claim 16, further comprising:
switching the display module based on a signal detected through the sensor.

19. The method of claim 18, wherein the switching the display module comprises at least one of:
adjusting an angle of the rear view provided through the display module based on the signal;
activating an anti-glare function for the display module based on the signal; and
switching the display module between a mirror mode for directly illuminating the rear view through reflection of light and a display mode for providing the rear view by displaying a rear view video of the vehicle based on the signal, and
the operating method further comprises at least one of:
returning the display module if a predetermined period of time elapses; and
returning the display module based on another signal detected through the sensor.

20. The operating method of claim 16, wherein the sensor includes at least one of a motion sensor, a proximity sensor, and a touch sensor.
